(19) United States
(12) Patent Application Publication
(10) Pub. No.: US 2016/0027313 A1
(43) Pub. Date: Jan. 28, 2016

(54) ENVIRONMENTALLY-AWARE LANDING ZONE CLASSIFICATION

(71) Applicant: Sikorsky Aircraft Corporation, Stratford, CT (US)

(72) Inventors: George Nicholas Loussides, Branford, CT (US); Igor Cherepinsky, Sandy Hook, CT (US); Michael Aaron Connor, Bridgeport, CT (US)

(21) Appl. No.: 14/797,572

(22) Filed: Jul. 13, 2015

Related U.S. Application Data
(60) Provisional application No. 62/027,321, filed on Jul. 22, 2014.

(51) Int. Cl. G08G 5/00; G01S 17/93

(52) U.S. Cl. CPC G08G 5/0069; G08G 5/006; G01S 17/933

(57) ABSTRACT

According to an aspect, a method of performing environmentally-aware landing zone classification for an aircraft includes receiving environmental sensor data indicative of environmental conditions external to the aircraft. Image sensor data indicative of terrain representing a potential landing zone for the aircraft are received. An environmentally-aware landing zone classification system of the aircraft evaluates the environmental sensor data to classify the potential landing zone relative to a database of landing zone types as environmentally-aware classification data. Geometric features of the potential landing zone are identified in the image sensor data as image-based landing zone classification data. The potential landing zone is classified and identified based on a fusion of the environmentally-aware classification data and the image-based landing zone classification data. A final landing zone classification is provided to landing zone selection logic of the aircraft based on the classifying and identifying of the potential landing zone.

### CROSS-REFERENCE TO RELATED APPLICATIONS

This application claims the benefit of U.S. provisional patent application Ser. No. 62/027,321 filed Jul. 22, 2014, the entire contents of which are incorporated herein by reference.

### BACKGROUND OF THE INVENTION

The subject matter disclosed herein generally relates to aircraft landing zone classification, and more particularly to environmentally-aware landing zone classification for an aircraft.

Optionally-piloted vehicles (OPVs) and unmanned aerial vehicles (UAVs) can operate without a human pilot using autonomous controls. As OPVs and UAVs become more prevalent, they are being operated in less restricted and controlled areas. When OPVs and UAVs are operated autonomously in flight, they must identify a landing zone prior to landing. To account for unpredictable landing zone conditions, OPVs and UAVs typically use an image-based system to identify geometric factors that may impede a safe landing. Current art on autonomous landing zone detection has focused on three-dimensional (3D) terrain-based data acquisition modalities, such as LIght Detection and Ranging scanners (LIDAR), LAser Detection and Ranging scanners (LADAR), and RAdio Detection And Ranging (RADAR) for autonomous landing zone detection. While images can be valuable in identifying a safe landing zone, geometric factors may not provide enough information to determine whether a seemingly flat surface is a suitable landing site. For example, it may be difficult for image-based systems to discriminate between a dry field and a surface of a body of water from only image information. Additionally, in a catastrophic area, other factors can impact landing zone safety.

### BRIEF DESCRIPTION OF THE INVENTION

According to an aspect of the invention, a method of performing environmentally-aware landing zone classification for an aircraft includes receiving environmental sensor data indicative of environmental conditions external to the aircraft. Image sensor data indicative of terrain representing a potential landing zone for the aircraft are received. An environmentally-aware landing zone classification system of the aircraft evaluates the environmental sensor data to classify the potential landing zone relative to a database of landing zone types as environmentally-aware classification data. Geometric features of the potential landing zone are identified in the image sensor data as image-based landing zone classification data. The potential landing zone is classified and identified based on a fusion of the environmentally-aware classification data and the image-based landing zone classification data. A final landing zone classification is provided to landing zone selection logic of the aircraft based on the classifying and identifying of the potential landing zone.

In addition to one or more of the features described above or below, or as an alternative, further embodiments could include where acquisition of the environmental sensor data and the image sensor data is time synchronized to correlate the environmentally-aware classification data and the image-based landing zone classification data during the fusion of data.

In addition to one or more of the features described above or below, or as an alternative, further embodiments could include where evaluating the environmental sensor data to classify the potential landing zone further includes comparing time correlated values from multiple environmental sensors in combination with mapping values of the environmental sensor data and differences between the environmental sensor data to the database of landing zone types.

In addition to one or more of the features described above or below, or as an alternative, further embodiments could include where a safety assessment is performed by comparing, for each type of environmental factor, the environmental sensor data against acceptable limits and making a safety determination based on collective results of the comparing.

In addition to one or more of the features described above or below, or as an alternative, further embodiments could include where the safety determination is provided directly to the landing zone selection logic of the aircraft.

In addition to one or more of the features described above or below, or as an alternative, further embodiments could include where one or more environmental sensors of the aircraft are controlled to target one or more features associated with the potential landing zone to perform the safety assessment.

In addition to one or more of the features described above or below, or as an alternative, further embodiments could include where the classifying and identifying of the potential landing zone further includes making an initial landing zone classification based on the image-based landing zone classification data, and reclassifying and identifying the potential landing zone as an adjustment to the initial landing zone classification based on the environmentally-aware classification data.

In addition to one or more of the features described above or below, or as an alternative, further embodiments could include receiving position data for the aircraft, and determining a geographic location of the potential landing zone based on the position data. The position data can be incorporated with the environmentally-aware classification data and the image-based landing zone classification data. A record of the environmentally-aware classification data and the image-based landing zone classification data can be stored based on the position data.

In addition to one or more of the features described above or below, or as an alternative, further embodiments could include where the environmental sensor data are received from one or more of: a noncontact pyrometer, a thermal-imaging camera, a noncontact infrared temperature sensor, a wind speed sensor, an ambient temperature sensor, a moisture sensor, radiation level detector, and a population-detection camera; and the image sensor data are received from one or more of: a LIght Detection and Ranging scanners (LIDAR) scanner, a video camera, a multi-spectral camera, a stereo camera system, a structure light-based 3D/depth sensor, a time-of-flight camera, a LAser Detection and Ranging scanners (LADAR) scanner, and a RAdio Detection And Ranging (RADAR) scanner.

In addition to one or more of the features described above or below, or as an alternative, further embodiments could include where the aircraft is autonomously controlled during landing based on a final landing zone selected by the landing zone selection logic in response to the final landing zone classification.

According to further aspects of the invention, a system for environmentally-aware landing zone classification for an aircraft is provided. The system includes a processor and memory having instructions stored thereon that, when executed by the processor, cause the system to receive environmental sensor data indicative of environmental conditions external to the aircraft. Image sensor data indicative of terrain representing a potential landing zone for the aircraft are received. The environmental sensor data are evaluated to classify the potential landing zone relative to a database of landing zone types as environmentally-aware classification data. Geometric features of the potential landing zone are identified in the image sensor data as image-based landing zone classification data. The potential landing zone is classified and identified based on a fusion of the environmentally-aware classification data and the image-based landing zone classification data. A final landing zone classification is provided to landing zone selection logic of the aircraft based on the classifying and identifying of the potential landing zone.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an exemplary rotary wing UAV aircraft according to an embodiment of the invention;

FIG. 2 is a schematic view of an exemplary computing system according to an embodiment of the invention; and

FIG. 3 illustrates a dataflow diagram of an environmentally-aware landing zone classifier according to an embodiment of the invention.

### DETAILED DESCRIPTION OF THE INVENTION

In exemplary embodiments, environmentally-aware landing zone classification is provided for an aircraft. The environmentally-aware landing zone classification operates in conjunction with other landing zone classification systems, such as image-based classification, to increase the probability of selecting a safe landing zone based on observed environmental factors. Examples of environmental factors that can be observed include fire, water, wind, radiation, population, and other such factors that could impede a safe landing on what appears to be otherwise unobstructed terrain. Environmentally-aware classification reduces the risk of potentially landing in a location that was determined acceptable based on geometric factors alone, but in reality would be a less desired and potentially catastrophic area. Embodiments do not rely upon environmental observations alone; rather, environmental data are used to augment geometric information captured from other sensors and/or databases, such as LIDAR, LADAR, RADAR, cameras, Digital Terrain Elevation Data (DTED), and other such systems known in the art. Data acquisition can be synchronized to fuse geometric image-based and environmental data.

The inclusion of environmental factors in landing zone selection further assists in determining a landing zone where an aircraft can potentially land and whether the landing zone appears safe. Environmentally-aware landing zone classification may be implemented in autonomous aircraft, such as optionally-piloted vehicles (OPVs) and unmanned aerial vehicles (UAVs), and/or may be provided to assist in human-piloted aircraft landing zone selection.

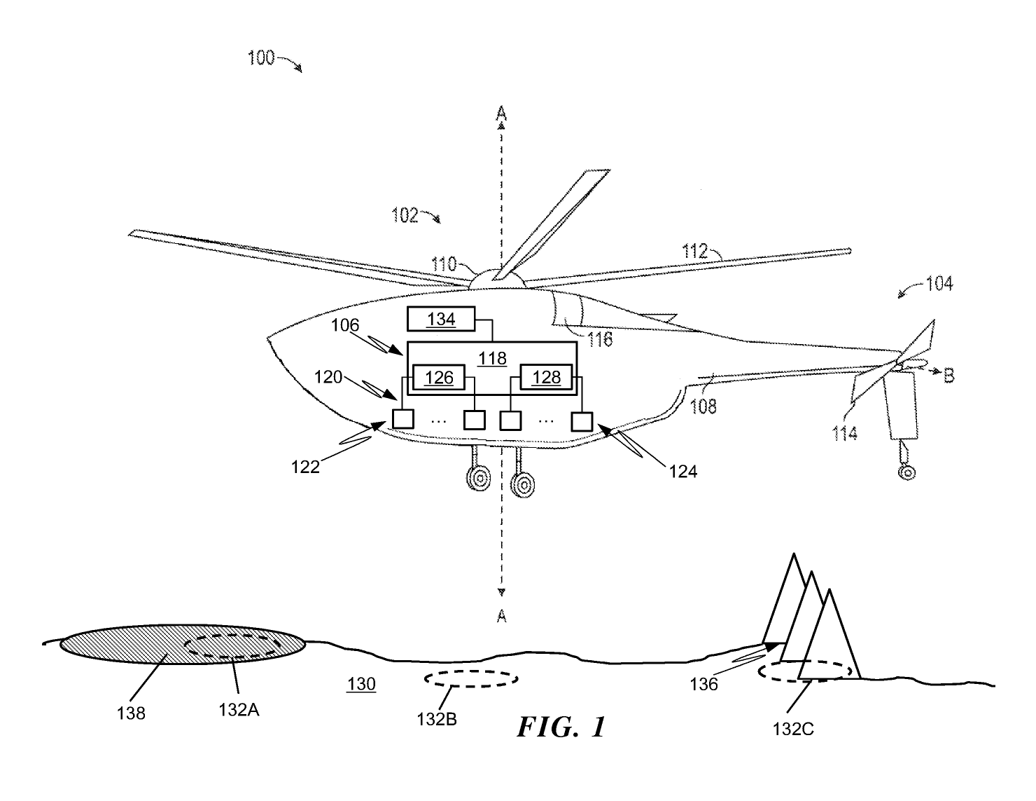

Referring now to the drawings, FIG. 1 illustrates a perspective of an exemplary vehicle in the form of an autonomous rotary-wing unmanned aerial vehicle (UAV) 100 (also referred to as “autonomous UAV 100” or “aircraft 100”) for implementing environmentally-aware landing zone classification according to an embodiment of the invention. As illustrated, the autonomous UAV 100 is an aircraft that includes a main rotor system 102, an anti-torque system, for example, a tail rotor system 104, and an environmentally-aware landing zone classification system 106. The main rotor system 102 is attached to an airframe 108 and includes a rotor hub 110 having a plurality of blades 112 that rotate about axis A. Also, the tail rotor system 104 is attached aft of the main rotor system 102 and includes a plurality of blades 114 that rotate about axis B (which is orthogonal to axis A). The main rotor system 102 and the tail rotor system 104 are driven to rotate about their respective axes A, B by one or more turbine engines 116 through gearboxes (not shown). Although a particular configuration of an autonomous UAV 100 is illustrated as a rotary wing UAV and described in the disclosed embodiments, it will be appreciated that other configurations and/or machines include autonomous, semi-autonomous, and human-controlled vehicles that may operate in land or water including fixed-wing aircraft, rotary-wing aircraft, marine vessels (e.g., submarines, ships, etc.), and land vehicles (e.g., trucks, cars, etc.) may also benefit from embodiments disclosed.

The environmentally-aware landing zone classification system 106 includes an aircraft computer system 118 having one or more processors and memory to process sensor data acquired from a sensing system 120. The sensing system 120 may be attached to or incorporated within the airframe 108. The sensing system 120 includes one or more environmental sensors 122 and one or more imaging sensors 124. The aircraft computer system 118 processes, in one non-limiting embodiment, raw data acquired through the sensing system 120 while the autonomous UAV 100 is airborne. An environmental sensor processing system 126 interfaces with the environmental sensors 122, while an image sensor processing system 128 interfaces with the imaging sensors 124. The environmental sensor processing system 126 and the image sensor processing system 128 may be incorporated within the aircraft computer system 118 or implemented as one or more separate processing systems that are in communication with the aircraft computer system 118 as part of the environmentally-aware landing zone classification system 106. The environmental sensors 122 can include but are not limited to: noncontact pyrometers for temperature measurement, thermal-imaging cameras, noncontact infrared temperature sensors, wind speed sensors, ambient temperature sensors, moisture sensors, radiation level detectors, and population-detection cameras. Accordingly, the environmental sensors 122 can be used to detect a variety of environmental factors external to the autonomous UAV 100, such as temperature, wind speed, population (human/animal), radiation (nuclear, electromagnetic), and the like, while the autonomous UAV 100 is airborne and in search of a landing site.

The imaging sensors 124 can capture image sensor data of a terrain 130 for processing by the aircraft computer system 118 while the autonomous UAV 100 is airborne. In an embodiment, the imaging sensors 124 may include one or more of: a downward-scanning LIDAR scanner, a video camera, a multi-spectral camera, a stereo camera system, a structure light-based 3D/depth sensor, a time-of-flight camera, a LADAR scanner, a RADAR scanner, or the like in order to capture image sensor data indicative of the terrain 130 and determine geometric information of one or more potential landing zones 132A, 132B, and 132C for the autonomous UAV 100. Additionally, the autonomous UAV 100 may include a navigation system 134, such as, for example, an inertial measurement unit (IMU) that may be used to acquire positional data related to a current rotation and acceleration of the autonomous UAV 100 in order to determine a geographic location of autonomous UAV 100, including a change in position of the autonomous UAV 100. The navigation system 134 can also or alternatively include a global positioning system (GPS) or the like to enhance positional awareness of the autonomous UAV 100.

In exemplary embodiments, the aircraft computer system 118 of the environmentally-aware landing zone classification system 106 performs an analysis of one or more potential landing zones 132A, 132B, and 132C based on both geometric and environmental factors. For example, terrain 130 that is observed by the environmentally-aware landing zone classification system 106 may include geometric impediments 136 (e.g., structures, trees, building, rocks, etc.), such as those depicted near potential landing zone 132C that may clearly rule out potential landing zone 132C as a safe landing zone. While potential landing zones 132A and 132B may both appear to be substantially flat surfaces, geometric analysis alone may be unable to accurately discern that potential landing zone 132A is located upon a water body 138. Using environmental factors extracted from the environmental sensors 122, such as temperature and moisture levels, potential landing zone 132A can be identified as water and therefore an unsafe landing zone. Landing zone classification and identification can perform a number of comparisons to determine suitability of multiple potential landing zones as further described herein.

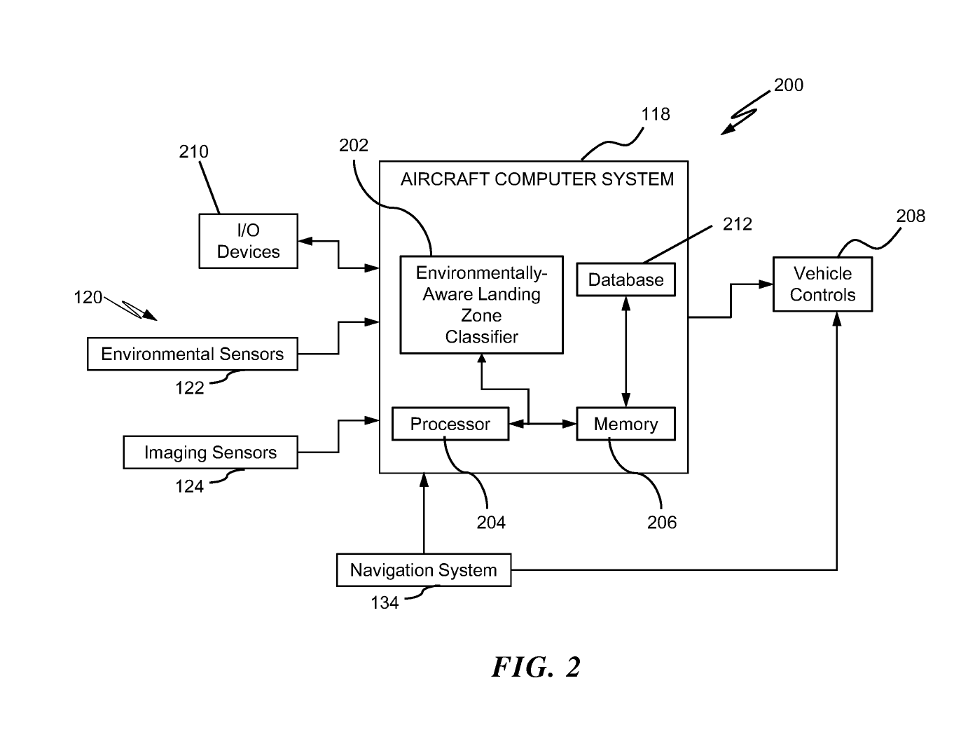

FIG. 2 illustrates a schematic block diagram of a system 200 for environmentally-aware landing zone classification onboard the autonomous UAV 100 of FIG. 1 according to an exemplary embodiment. The system 200 is an embodiment of the environmentally-aware landing zone classification system 106 of FIG. 1. As illustrated, the system 200 includes the aircraft computer system 118 that executes instructions for implementing an environmentally-aware landing zone classifier 202. The aircraft computer system 118 receives raw sensor data on potential landing zones from one or more environmental sensors 122 and one or more imaging sensors 124. As depicted in FIG. 2, the aircraft computer system 118 includes a memory 206 that communicates with a processor 204. The memory 206 may store the environmentally-aware landing zone classifier 202 as executable instructions that are executed by processor 204. The memory 206 is an example of a non-transitory computer readable storage medium tangibly embodied in the aircraft computer system 118 including executable instructions stored therein, for instance, as firmware. Also, in embodiments, memory 206 may include random access memory (RAM), read-only memory (ROM), or other electronic, optical, magnetic or any other computer readable medium onto which instructions and data are stored. The processor 204 may be any type of processor, including a general purpose processor, a digital signal processor, a microcontroller, an application specific integrated circuit, a field programmable gate array, or the like. Although depicted as singular blocks, the processor 204 and memory 206 can be distributed between multiple processing circuits and memory subsystems. In an embodiment, the processor 204 performs functions of the environmental sensor processing system 126 (FIG. 1) and the image sensor processing system 128 (FIG. 1).

The system 200 may include a database 212. The database 212 may be used to store potential landing zone profiles, safety limits, position data from navigation system 134, geometric profiles, environmental profiles, and the like. The data stored in the database 212 may be based on one or more other algorithms or processes for implementing the environmentally-aware landing zone classifier 202. For example, in some embodiments data stored in the database 212 may be a result of the processor 204 having subjected data received from the sensing system 120 to one or more filtration processes. The database 212 may be used for any number of reasons. For example, the database 212 may be used to temporarily or permanently store data, to provide a record or log of the data stored therein for subsequent examination or analysis, etc. In some embodiments, the database 212 may store a relationship between data, such as one or more links between data or sets of data acquired through the modalities onboard the autonomous UAV 100 to support data fusion.

The system 200 may provide one or more controls, such as vehicle controls 208. The vehicle controls 208 may provide directives based on, e.g., data associated with the navigation system 134. Directives provided by the vehicle controls 208 may include navigating or repositioning the autonomous UAV 100 to an alternate landing zone for evaluation as a suitable landing zone. The directives may be presented on one or more input/output (I/O) devices 210. The I/O devices 210 may include a display device or screen, audio speakers, a graphical user interface (GUI), etc. In some embodiments, the I/O devices 210 may be used to enter or adjust a linking between data or sets of data. It is to be appreciated that the system 200 is illustrative. In some embodiments, additional components or entities not shown in FIG. 2 may be included. In some embodiments, one or more of the components or entities may be optional. In some embodiments, the components or entities of the system 200 may be arranged or configured differently from what is shown in FIG. 2. For example, in some embodiments the I/O device(s) 210 may be commanded by vehicle controls 208, as opposed to being commanded by the processor 204.

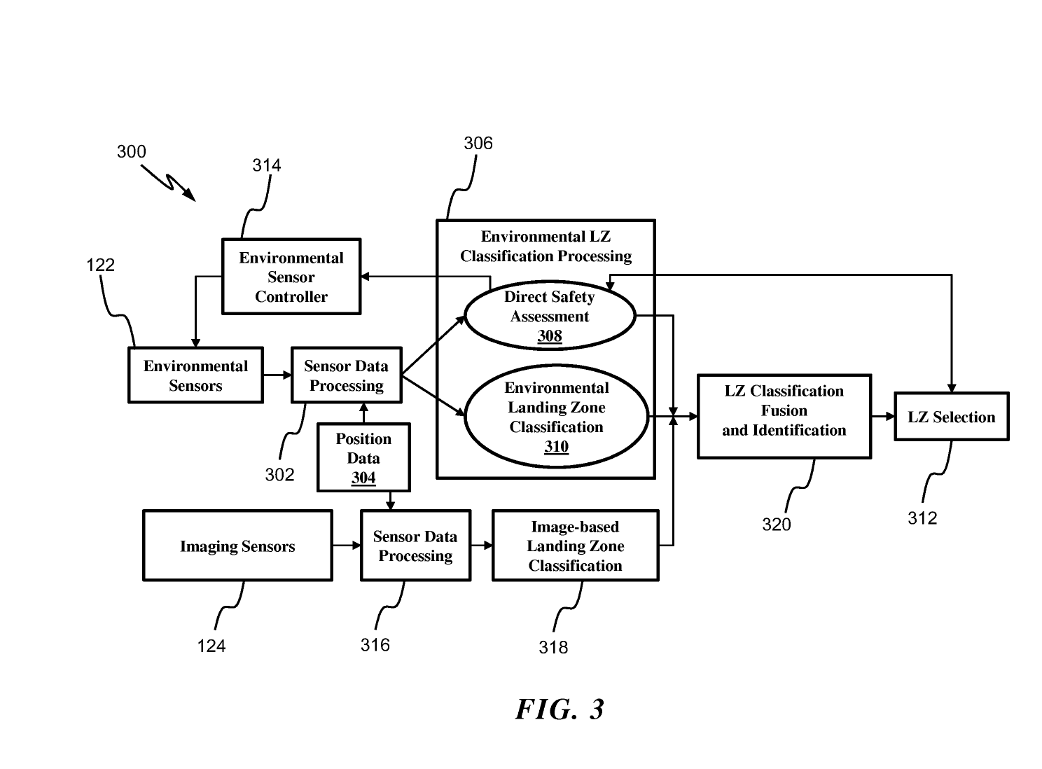

FIG. 3 illustrates an exemplary data flow diagram 300 that is performed by the processor 204 of FIG. 2 for implementing the environmentally-aware landing zone classifier 202 of FIG. 2 according to an embodiment. Environmental sensor data indicative of environmental conditions external to the autonomous UAV 100 of FIG. 1 is received at sensor data processing 302 from the environmental sensors 122. The sensor data processing 302 may also receive position data 304, for example, from the navigation system 134 of FIGS. 1 and 2. Environmental landing zone classification processing 306 includes direct safety assessment logic 308 and environmental landing zone classification logic 310. The environmental landing zone classification processing 306 is an example of processing performed by the environmental sensor processing system 126 of FIG. 1. The sensor data processing 302 can provide the environmental sensor data to both the direct safety assessment logic 308 and environmental landing zone classification logic 310.

The direct safety assessment logic 308 makes a direct safety assessment of the potential landing zones 132A-132C of FIG. 1 based on the environmental sensor data without attempting to identify a specific landing zone type. The direct safety assessment logic 308 may analyze the environmental sensor data for a number of environmental factors, such as temperature, wind speed, population (human/animal), radiation (nuclear, electromagnetic), and the like. In an embodiment, the direct safety assessment logic 308 performs a safety assessment by comparing, for each type of environmental factor, the environmental sensor data against acceptable limits and makes a safety determination based on collective results of the comparing. The safety determination can be provided directly to landing zone selection logic 312 of the autonomous UAV 100 of FIG. 1. The direct safety assessment logic 308 can also control one or more of the environmental sensors 122 of the autonomous UAV 100 of FIG. 1 via an environmental sensor controller 314 to target one or more features associated with a potential landing zone to perform the safety assessment. For example, targeted temperature readings may be taken at physical coordinates that align with each of the potential landing zones 132A-132C of FIG. 1.

The environmental landing zone classification logic 310 can evaluate the environmental sensor data to classify potential landing zones 132A-132C of FIG. 1 relative to database 212 (FIG. 2) of landing zone types as environmentally-aware classification data. Evaluation of the environmental sensor data to classify the potential landing zone may include comparing time correlated values from multiple environmental sensors 122 in combination with mapping values of the environmental sensor data and differences between the environmental sensor data to the database 212 (FIG. 2) of landing zone types. For example, a difference between a surface and ambient temperature can be evaluated to classify the potential landing zone 132A as a body of water, where a correlation is expected between a surface temperature and a temperature of the water body 138 of FIG. 1 versus ambient temperature.

Image sensor data indicative of terrain 130 (FIG. 1) representing potential landing zones 132A-132C for the autonomous UAV 100 of FIG. 1 is received at sensor data processing 316 from the imaging sensors 124. The sensor data processing 316 may also receive position data 304, for example, from the navigation system 134 of FIGS. 1 and 2. Image-based landing zone classification 318 identifies geometric features of the potential landing zones 132A-132C in the image sensor data as image-based landing zone classification data. The image-based landing zone classification 318 is an example of processing performed by the image sensor processing system 128 of FIG. 1. Reference images stored in database 212 (FIG. 2) can be used to extract geometric features using known image processing techniques, such as a scale-invariant feature transform.

Landing zone classification fusion and identification logic 320 can classify and identify the potential landing zones 132A-132C of FIG. 1 based on a fusion of the environmentally-aware classification data from the environmental landing zone classification logic 310 and the image-based landing zone classification data from the image-based landing zone classification 318. In an embodiment, acquisition of the environmental sensor data and the image sensor data is time synchronized to correlate the environmentally-aware classification data and the image-based landing zone classification data during the fusion of data. The landing zone classification fusion and identification logic 320 can also receive a continuous stream of safety assessment information from the direct safety assessment logic 308 to fuse with the environmentally-aware classification data and the image-based landing zone classification data. Identification processing may tag the potential landing zones 132A-132C of FIG. 1 as safe ground, icy ground, frozen water, liquid water, fire, radio-active, densely populated, wet slope, dry slope, etc. Maps in the database 212 of FIG. 2 can establish relative degrees of classification and identification, such as mapping threshold limits or ratios to quantitatively define limits for safe/unsafe, too hot/too cold, and other such relative assessments.

Data fusion can also combine geographic location information with geometric and environmental features. For example, geographic locations of the potential landing zones 132A-132C of FIG. 1 can be determined based on the position data 304. The position data 304 may be incorporated with the environmentally-aware classification data and the image-based landing zone classification data. A record of the environmentally-aware classification data and the image-based landing zone classification data can be stored in the database 212 of FIG. 2 based on the position data 304.

As this data is collected over a period of time, profiles can be constructed to determine classification and identification confidence of the potential landing zones 132A-132C of FIG. 1. Classifying and identifying of the potential landing zones 132A-132C of FIG. 1 by the landing zone classification fusion and identification logic 320 may further include making an initial landing zone classification based on the image-based landing zone classification data, and reclassifying and identifying the potential landing zones 132A-132C of FIG. 1 as adjustments to the initial landing zone classification based on the environmentally-aware classification data.

The landing zone classification fusion and identification logic 320 provides a final landing zone classification to the landing zone selection logic 312 of the autonomous UAV 100 based on the classifying and identifying of the potential landing zones 132A-132C of FIG. 1. Upon receiving a final landing zone classification for each of the potential landing zones 132A-132C of FIG. 1, the landing zone selection logic 312 can create an ordered list of preferred landing zones and eliminate potential landing zones identified as unsafe. The landing zone selection logic 312 may apply a number of factors when selecting a final landing zone, such as probability of sustaining damage associated with each type of landing zone, projected difficulty in reaching each potential landing zone, and other landing zone selection algorithms known in the art. The autonomous UAV 100 can be autonomously controlled during landing using the vehicle controls 208 of FIG. 2 based on the final landing zone selected by the landing zone selection logic 312 in response to the final landing zone classification of the landing zone classification fusion and identification logic 320.

Technical effects include potential landing zone selection for an aircraft based on environmental factors and geometric factors of the potential landing zone.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of performing environmentally-aware landing zone classification for an aircraft, the method comprising:
receiving environmental sensor data indicative of environmental conditions external to the aircraft;
receiving image sensor data indicative of terrain representing a potential landing zone for the aircraft;
evaluating, by an environmentally-aware landing zone classification system of the aircraft, the environmental sensor data to classify the potential landing zone relative to a database of landing zone types as environmentally-aware classification data;
identifying geometric features of the potential landing zone in the image sensor data as image-based landing zone classification data;
classifying and identifying the potential landing zone based on a fusion of the environmentally-aware classification data and the image-based landing zone classification data; and
providing a final landing zone classification to landing zone selection logic of the aircraft based on the classifying and identifying of the potential landing zone.

2. The method of claim 1, wherein acquisition of the environmental sensor data and the image sensor data is time synchronized to correlate the environmentally-aware classification data and the image-based landing zone classification data during the fusion of data.

3. The method of claim 1, wherein evaluating the environmental sensor data to classify the potential landing zone further comprises comparing time correlated values from multiple environmental sensors in combination with mapping values of the environmental sensor data and differences between the environmental sensor data to the database of landing zone types.

4. The method of claim 1, further comprising:
performing a safety assessment by comparing, for each type of environmental factor, the environmental sensor data against acceptable limits and making a safety determination based on collective results of the comparing.

5. The method of claim 4, further comprising:
providing the safety determination directly to the landing zone selection logic of the aircraft.

6. The method of claim 4, further comprising:
controlling one or more environmental sensors of the aircraft to target one or more features associated with the potential landing zone to perform the safety assessment.

7. The method of claim 1, wherein the classifying and identifying of the potential landing zone further comprises making an initial landing zone classification based on the image-based landing zone classification data, and reclassifying and identifying the potential landing zone as an adjustment to the initial landing zone classification based on the environmentally-aware classification data.

8. The method of claim 1, further comprising:
receiving position data for the aircraft;
determining a geographic location of the potential landing zone based on the position data;
incorporating the position data with the environmentally-aware classification data and the image-based landing zone classification data; and
storing a record of the environmentally-aware classification data and the image-based landing zone classification data based on the position data.

9. The method of claim 1, wherein the environmental sensor data are received from one or more of: a noncontact pyrometer, a thermal-imaging camera, a noncontact infrared temperature sensor, a wind speed sensor, an ambient temperature sensor, a moisture sensor, radiation level detector, and a population-detection camera; and the image sensor data are received from one or more of: a LIght Detection and Ranging scanners (LIDAR) scanner, a video camera, a multi-spectral camera, a stereo camera system, a structure light-based 3D/depth sensor, a time-of-flight camera, a LAser Detection and Ranging scanners (LADAR) scanner, and a RAdio Detection And Ranging (RADAR) scanner.

10. The method of claim 1, wherein the aircraft is autonomously controlled during landing based on a final landing zone selected by the landing zone selection logic in response to the final landing zone classification.

11. A system for environmentally-aware landing zone classification for an aircraft, the system comprising:
a processor; and
memory having instructions stored thereon that, when executed by the processor, cause the system to:
receive environmental sensor data indicative of environmental conditions external to the aircraft;
receive image sensor data indicative of terrain representing a potential landing zone for the aircraft;
evaluate the environmental sensor data to classify the potential landing zone relative to a database of landing zone types as environmentally-aware classification data;
identify geometric features of the potential landing zone in the image sensor data as image-based landing zone classification data;
classify and identify the potential landing zone based on a fusion of the environmentally-aware classification data and the image-based landing zone classification data; and
provide a final landing zone classification to landing zone selection logic of the aircraft based on the classifying and identifying of the potential landing zone.

12. The system of claim 11, wherein acquisition of the environmental sensor data and the image sensor data is time synchronized to correlate the environmentally-aware classification data and the image-based landing zone classification data during the fusion of data.

13. The system of claim 11, wherein evaluation of the environmental sensor data to classify the potential landing zone further comprises a comparison of time correlated values from multiple environmental sensors in combination with mapping values of the environmental sensor data and differences between the environmental sensor data to the database of landing zone types.

14. The system of claim 11, wherein a safety assessment is performed by comparing, for each type of environmental factor, the environmental sensor data against acceptable limits, and a safety determination is made based on collective results of the comparing.

15. The system of claim 11, wherein the classification and identification of the potential landing zone further comprises making an initial landing zone classification based on the image-based landing zone classification data, and reclassifying and identifying the potential landing zone as an adjustment to the initial landing zone classification based on the environmentally-aware classification data.
